(19) United States
(12) Patent Application Publication
(10) Pub. No.: US 2026/0255302 A1
(43) Pub. Date: Aug. 27, 2026

(54) METHOD AND APPARATUS FOR POSITIONING

(71) Applicant: Samsung Electronics Co., Ltd., Gyeonggi-do (KR)

(72) Inventors: Qi XIONG, Beijing (CN); Longhai ZHAO, Beijing (CN); Feifei SUN, Beijing (CN)

(21) Appl. No.: 18/992,429

(22) PCT Filed: Jul. 14, 2023
(86) PCT No.: PCT/KR2023/010092

§ 371 Date: Jan. 8, 2025

(30) Foreign Application Priority Data
Jul. 14, 2022 (CN) 202210834167.2

(51) Int. Cl. H04W 64/00; H04L 25/02

(52) U.S. Cl. CPC H04W 64/00; H04L 25/0212

(57) ABSTRACT

The disclosure relates to a 5G or 6G communication system for supporting a higher data transmission rate. Embodiments of the present disclosure provide a method and apparatus for positioning, relating to the technical field of artificial intelligence. The method, performed by a first node in a communication system, the method may comprises obtaining related information of a positioning method or model, obtaining positioning information based on the related information of the positioning method or model, and performing positioning-related operations based on the positioning information.

### TECHNICAL FIELD

The present disclosure relates to the technical field of artificial intelligence, and in particular, the present disclosure relates to a method performed by a first node and a related device for positioning.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for positioning.

### Solution to Problem

Embodiments of the present disclosure provide a method performed by a first node and a related device, which can solve at least one technical problem in related technologies. The technical solutions will be described below.

According to an aspect of the embodiments of the present disclosure, a method performed by a first node is provided, including, obtaining related information of the positioning method or model, and obtaining positioning information based on the related information of the positioning method or model.

In an embodiment, the related information of the positioning method or model includes at least one of the following: composition-related information of the method or model, type-related information of the method or model, parameter-related information of the method or model, and dataset-related information.

In an embodiment, the positioning information includes at least one of the following:
position information, information related to the calculation of position information, time of arrival of the signal, angle of arrival, and angle of departure.

In an embodiment, the method further includes: obtaining input information, the input information including dataset-related information, obtaining positioning information includes:
obtaining the positioning information based on the input information, wherein the input information is obtained through at least one of the following means, obtaining the input information by receiving and/or measuring a first signal, and receiving the input information from a second node.

In an embodiment, the method further includes: receiving a positioning-related request sent by a second node, or receiving a positioning-related request sent by upper layers, and obtaining positioning information includes: obtaining positioning information based on the request.

In an embodiment, obtaining positioning information includes: obtaining positioning information when at least one of the following trigger conditions is met: a measured reference signal receiving power value of a first signal is not greater than a first threshold value, a measured path loss of a first signal is not less than a second threshold value, the positioning method or model is in a valid state, and when the trigger condition occurs not less than N times.

In an embodiment, the first signal includes at least one of the following: a positioning reference signal, a sounding reference signal, a reference signal of a synchronization signal block, and a reference signal of channel state information.

In an embodiment, the method further includes: receiving signaling configured to activate the positioning method or model.

In an embodiment, the signaling includes at least one of the following: LTE a positioning protocol (LPP) message, a radio resource control configuration message, a medium access control control element, downlink control information, physical uplink control information, and physical random access channel.

In an embodiment, the dataset-related information includes number-related information and the number-related information includes at least one of the following: the number of channel impulse responses based on a third threshold value, and the first N channel impulse responses in terms of time of arrival and/or largest N channel impulse responses in terms of power.

In an embodiment, the parameter-related information of the method or model includes at least one of the following: a probability distribution for determining initial weight parameters and/or bias parameters, weight parameter configuration and/or bias parameter configuration, and a training optimization algorithm and/or a loss function and/or epoch times and/or a learning rate, for obtaining or updating weight parameters and/or bias parameters.

In an embodiment, the method further includes: determining the validity of the positioning method or model, when valid, obtaining the positioning information.

In an embodiment, determining the validity of the positioning method or model includes: obtaining first data, determining that the positioning method or model is valid when the output information obtained by the positioning method or model based on the input information in the first data meets any one of the following preset conditions: the difference between the output information and the output information in the first data is not greater than a test threshold value, and the model performance corresponding to the output information is better than the model performance corresponding to the output information in the first data.

In an embodiment, the method further includes at least one of the following: based on a preset event, counting information and/or timing information, triggering an update of the related information of the positioning method or model, based on a preset event, counting information and/or timing information, triggering restoring of the related information of the positioning method or model, and based on a preset event, counting information and/or timing information, terminating the use of the related information of the positioning method or model, wherein the preset event includes at least one of the following: output information of the positioning method or model does not meet the required threshold value; and the number and/or type of input information used for the positioning method or model does not meet the required threshold value, the timing information includes at least one of the following: a start time when the positioning method or model is determined to be used, a start time corresponding to the preset event, and a termination time corresponding to the preset event, and the counting information includes at least one of the following: an initial value corresponding to the preset event, and an accumulated value corresponding to the occurrence of the preset event.

In an embodiment, obtaining positioning information based on the input information includes at least one of the following: determining, based on a first noise value corresponding to the input information, whether the input information needs to initiate denoise operation; if so, processing the input information through a first module of the positioning method or model to obtain first denoised information, and processing the first denoised information through a second module of the positioning method or model to obtain positioning information; and if not, processing the input information through the second module to obtain positioning information, and determining, based on a channel impulse response value corresponding to the input information, whether the input information needs to initiate recovery operation; if so, processing the input information through a first module for the positioning method or model to obtain first recovered information, and processing the first recovered information through a second module for the positioning method or model to obtain positioning information; and if not, processing the input information through the second module to obtain positioning information.

In an embodiment, determining, based on a first noise value corresponding to the input information, whether the input information needs to initiate denoise operation includes: comparing the first noise value corresponding to the input information with a first noise threshold value to determine whether the input information needs to initiate denoise operation.

In an embodiment, determining, based on a channel impulse response value corresponding to the input information, whether the input information needs to initiate recovery operation includes: comparing the channel impulse response CIR value corresponding to the input information with a first CIR threshold value to obtain a number of valid CIR values, and comparing the number of valid CIR values with a first threshold value of the number of CIRs to determine whether the input information needs to initiate recovery operation.

In an embodiment, the first noise value includes at least one of the following: RSRP, SNR, CIR amplitude value, and CIR arrival time value.

In an embodiment, the first node includes one of the following: a user equipment UE, a location management entity for UE positioning and positioning assistance data delivery, a base station or a transmission-reception point for broadcasting positioning assistance data and performing uplink positioning measurement, and a UE for downlink positioning measurement, and the second node includes one of the following: a user equipment UE that initiates a positioning request, a location management entity for UE positioning and positioning assistance data delivery, a base station or a transmission-reception point for broadcasting positioning assistance data and performing uplink positioning measurement, and a UE for downlink positioning measurement.

According to another aspect of the embodiments of the present disclosure, an apparatus performed by a first node is provided, including: a first obtaining module, configured to obtain related information of the positioning method or model, and a second obtaining module, configured to obtain positioning information based on the related information of the positioning method or model.

According to another aspect of the embodiments of the present disclosure, an electronic device is provided, including: a transceiver, and a controller coupled to the transceiver and configured to execute the method performed by the first node.

According to still another aspect of the embodiments of the present disclosure, a computer-readable storage medium is provided, configured to store computer instructions that, when run on a computer, cause the computer to execute the method performed by the first node.

According to an aspect of the embodiments of the present disclosure, a computer program product is provided, including computer programs or instructions that, when executed by a processor, implement steps of the method performed by the first node.

According to an aspect of the embodiments of the present disclosure, a method performed by a first node is provided, including: after obtaining related information of the positioning method or model, positioning information may be obtained based on the related information of the positioning method or model. The implementation of the present disclosure uses AL/ML technology, which can obtain positioning information based on the related information of the positioning method or model obtained in a specific scenario, and can perform positioning-related operations in poor channel conditions (for example inaccurate channel information) or in “harsh” conditions (for example, non-line-of-sight environment), such as, obtaining positioning information, performing subsequent positioning operations based on the positioning information, and so on.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and apparatus for positioning.

### BRIEF DESCRIPTION OF DRAWINGS

To describe the technical solutions of the embodiments of the present disclosure more clearly, the drawings to be used in the description of the embodiments of the present disclosure will be described briefly.

FIG. 1 illustrates an example wireless network according to various embodiments of the present disclosure;

FIG. 2a illustrates an example wireless transmission path according to the present disclosure;

FIG. 2b illustrates an example wireless receive path according to the present disclosure;

FIG. 3a illustrates an example user equipment according to the present disclosure;

FIG. 3b illustrates an example base station according to the present disclosure;

FIG. 4 illustrates a block diagram of a user equipment used in a method for receiving and measuring a positioning signal according to an embodiment of the present disclosure;

FIG. 5 illustrates a schematic flowchart of a method performed by a first node provided in the present disclosure;

FIG. 6 illustrates a schematic diagram of a processing flow of a positioning method or a positioning model provided in the present disclosure;

FIG. 7 illustrates a schematic structure diagram of an apparatus performed by a first node provided in the present disclosure; and

FIG. 8 is a schematic structure diagram of an electronic device provided in the present disclosure.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

The technical solution of the embodiments of the present disclosure can be applied to various communication systems, such as global system for mobile communications (GSM) system, code division multiple access (CDMA) system, (wideband code division multiple access (WCDMA) system, general packet radio service (GPRS), Long term evolution (LTE) system, LTE frequency division duplex (FDD) system, LTE time division duplex (TDD) system, universal mobile telecommunication system (UMTS), worldwide interoperability for microwave access (WiMAX) communication system, 5th generation (5G) system or new radio (NR) system, etc. In addition, the technical solution of the embodiments of the present disclosure can be applied to future-oriented communication technology.

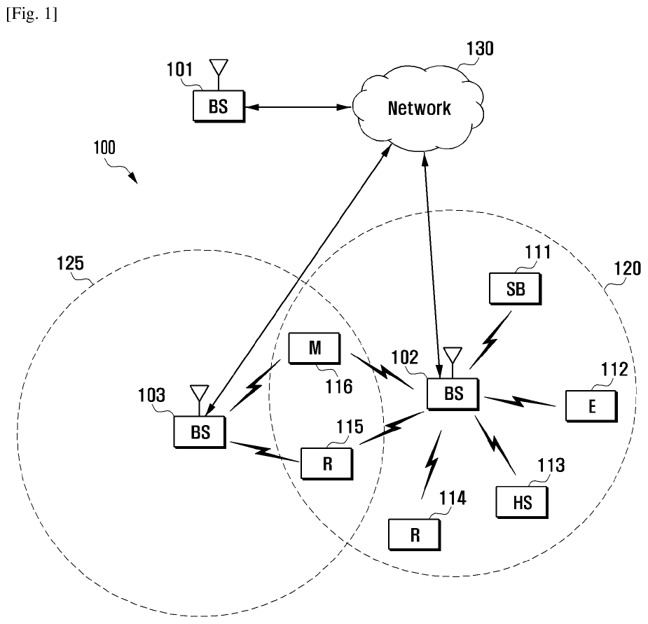

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

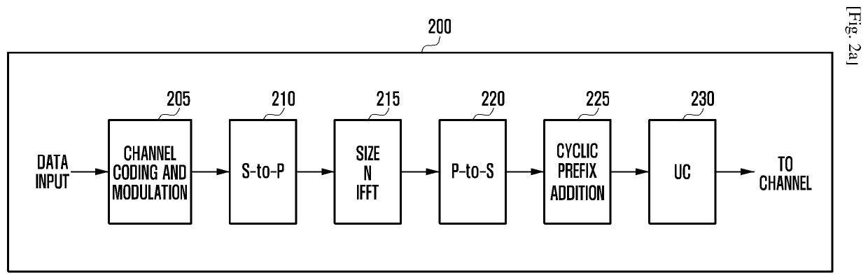

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

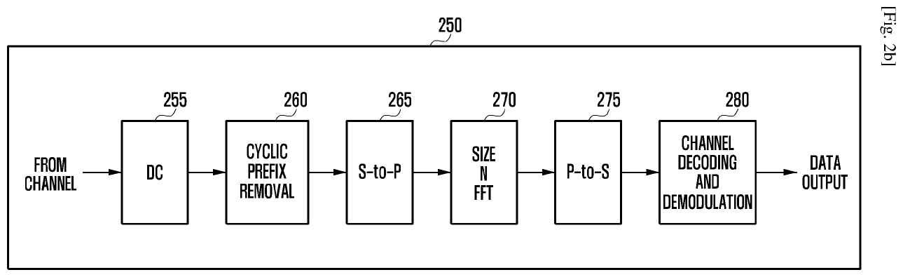

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The time domain unit (also called time unit) in the present disclosure may be: an OFDM symbol, an OFDM symbol group (composed of multiple OFDM symbols), a time slot, a time slot group (composed of multiple time slots), a subframe, a subframe group (composed of multiple subframes), a system frame, a system frame group (composed of multiple system frames); it may also be an absolute time unit, for example, 1 millisecond, 1 second, etc.; the time unit may also be a combination of multiple granularities, for example, N1 time slots plus N2 OFDM symbols.

The frequency domain unit (also called frequency unit) in the present disclosure may be: a subcarrier, a subcarrier group (composed of multiple subcarriers), a resource block (RB, which may also be called a physical resource block (PRB)), a resource block group (composed of multiple RBs), a bandwidth part (BWP), a bandwidth part group (composed of multiple BWPs), a frequency band/carrier, a frequency band group/carrier group; it may also be an absolute frequency domain unit, for example, 1 Hz, 1 kilohertz, etc.; the frequency domain unit may also be a combination of multiple granularities, for example, M1 PRBs plus M2 subcarriers.

Exemplary embodiments of the present disclosure will be further described below with reference to the accompanying drawings.

The text and drawings are provided as examples only to assist the readers in understanding the present disclosure. They are not intended and should not be construed to limit the scope of the present disclosure in any way. Although some embodiments and examples have been provided, it will be apparent to those skilled in the art based on the disclosure herein that the illustrated embodiments and examples can be modified without departing from the scope of the present disclosure.

It may be understood by those skilled in the art that singular forms “a”, “an”, “said”, and “the” may be intended to include plural forms as well, unless otherwise stated. It should be further understood that terms “include/including” used in this specification specify the presence of the stated features, integers, steps, operations, elements and/or components, but not exclusive of the presence or addition of one or more other features, integers, steps, operations, elements, components, and/or combinations thereof. It should be understood that, in the embodiments of the present disclosure, when an element is referred to as being “connected to” or “coupled to” another element, it may be directly connected or coupled to other elements or provided with intervening elements there between. In addition, “connected to” or “coupled to” as used herein may include wireless connection or coupling. As used herein, the wording “and/or” includes all or any of one or more associated listed items or combinations thereof.

It may be understood by those skilled in the art that, unless otherwise defined, all terms (including technical and scientific terms) used herein have the same meaning as commonly understood by a person of ordinary skill in the art to which the present disclosure belongs. It should also be understood that terms, such as those defined in a general dictionary, should be understood to have meanings consistent with their meanings in the context of the prior art and, unless specifically defined as herein, should not be interpreted in idealistic or overly formal meaning.

It may be understood by those skilled in the art that “terminals” and “terminal devices” as used herein include not only devices with wireless signal receivers, that is, devices with wireless signal receivers that are capable of transmission, but also devices with receiving and transmitting hardware, that is, devices with receiving and transmitting hardware that is capable of bi-directional communication over bi-directional communication links. Such devices may include: cellular or other communication devices with single-line displays or multi-line displays, or cellular or other communication devices without multi-line displays; PCSs (Personal Communications Services), which may integrate voice, data Processing, facsimile and/or data communication; PDAs (Personal Digital Assistants), which may include radio frequency receivers, pagers, internet/intranet access, web browsers, notepads, calendar and/or GPS (Global Positioning System) receivers; conventional laptop and/or palmtop computers or other devices, conventional laptop and/or palmtop computers or other devices having and/or including radio frequency receivers. “Terminals” and “terminal devices” as used herein may be portable, transportable, installed in vehicles (air vehicles, marine vehicles and/or land vehicles), or may be adapted and/or configured to operate locally, and/or operate at any other positions on Earth and/or in space in distributed form. “Terminals” and “terminal devices” as used herein may also be communication terminals, internet terminals, and music/video player terminals. For example, they may be PDAs, MIDs (Mobile Internet Devices) and/or mobile phones with the music/video play function; and they may also be smart TVs, set-top boxes and other devices.

In the present disclosure, the term “send” may be used interchangeably with “transmit”, “report”, “notify”, etc. without departing from the scope of the present disclosure.

The text and drawings are provided as examples only to assist the readers in understanding the present disclosure. They are not intended and should not be construed to limit the scope of the present disclosure in any way. Although some embodiments and examples have been provided, it will be apparent to those skilled in the art based on the disclosure herein that the illustrated embodiments and examples can be modified without departing from the scope of the present disclosure.

The transmission links of the wireless communication system mainly include: downlink communication links from 5G gNB to UE (User Equipment), and uplink communication links from UE to the network.

Nodes used for positioning measurement in the wireless communication systems such as the current wireless communication system include: a UE that initiates a positioning request message, a location management entity (LMF) used for UE positioning and positioning assistance data delivery, and a gNB or transmission-reception point (TRP) for broadcasting positioning assistance data and uplink positioning measurement, and a UE for downlink positioning measurement. In addition, the method of the present disclosure may also be extended to other communication systems, for example vehicle communication (V2X), that is, side link communication. In this case, the transmission-reception point or UE may be any device in V2X.

In recent years, artificial intelligence (AI) represented by deep learning algorithms has risen, has solved problems in various industries for many years, and has achieved great technical and commercial success. With the continuous evolution of wireless communication systems, problems in the air interfaces have been studied, and great effort has been paid to introduce new methods to solve these problems. In order to solve some problems in the communication process, machine learning may be used. Machine learning (ML) usually include design of machine learning algorithms and design of positioning methods or models on which the algorithms are based. Solutions based on AI deep learning (DL) usually refer to algorithms modeled on artificial neural networks in machine learning technology. A deep learning network model is usually composed of multiple stacked artificial neural networks. Weight parameters in the neural networks are adjusted by training on existing data, and then used in the inference stage to accomplish tasks in un-occurred situations. Meanwhile, generally speaking, compared to general fixed-rule-based solutions or algorithms, DL-based solutions need relatively more computing power than related classical algorithms, which usually requires devices running DL algorithms to have dedicated computing chips to support more efficient operation of DL algorithms.

Using machine learning-based AI algorithms to solve problems in communication usually needs to meet the conditions of machine learning. Among the existing problems related to the air interfaces in communication, obtaining device position is a typical problem that meets the above conditions to a certain extent, so machine learning algorithms may be used to solve it and can achieve better effect in the process of communication transmission than related solutions for example in non-line-of-sight environments.

Although for the currently used wireless communication systems, the related positioning algorithms can provide normal services in some scenarios; however, for machine learning algorithms, due to their completely different architecture and characteristics from traditional algorithms, their usage methods are completely different from traditional ones. Today's wireless communication systems (4G, 5G, and possible 6G wireless communication systems in the future) have strict and unified standards to limit the configuration method and behavior process of the air interfaces in the communication process. Therefore, considering the use of the new technology of machine learning in a new generation of wireless communication systems, air interfaces must be designed in combination with the characteristics of new communication systems and machine learning algorithms. For the implementation of the machine learning-based algorithms in the air interfaces in the wireless communication systems, it is necessary to specify the specific implementation process, for example, how signals are transmitted and interacted between the user equipment and the base station, the process of activating and deactivating the machine learning algorithms and models, the update of machine learning algorithms and models in the use process, etc., all of which need to be considered.

Therefore, for the above problems, in order to use machine learning-based solutions in wireless communication systems, it is necessary to propose effective technical methods to specify the specific methods for implementing these solutions in the systems, the processes that need to set, etc., to establish a suitable framework for machine learning-based methods to solve air interface-related problems in wireless communications.

In the present disclosure, the first method used includes: “machine learning-based algorithms and models”, “AI (artificial intelligence)/ML (machine learning)-based technology”, “AI/ML for NR air interfaces”, “AI/ML technology”, “AI/ML architectures”, “AI/ML models”, “AI/ML for air interfaces”, “AI/ML methods” and “AI/ML-related algorithms”, “AI/ML-based algorithms” and “AI/ML solutions”.

The present disclosure provides a machine learning-based algorithm and model applied and configured in a wireless communication system to complete or realize the positioning operation and acquisition of positioning information of the wireless communication system. The purpose of the present disclosure is to solve how to use machine learning-based solutions in wireless communication systems to solve the problems that need to be solved in the air interfaces in wireless communication, propose architectures, processes, methods, etc. for using machine learning solutions in wireless communication systems, and to realize the application of machine learning algorithms in wireless communication systems by designing these architectures, processes, methods, etc. so that machine learning methods with better effects than related existing methods can be successfully used and implemented in communication systems, and accordingly, the positioning method based on machine learning can be better applied to the actual wireless communication systems.

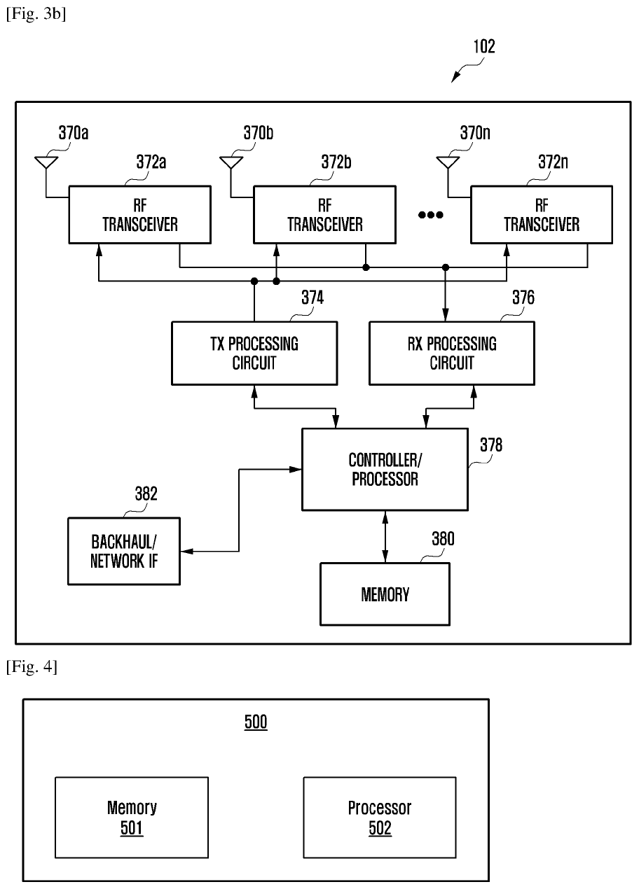

The method performed by a first node provided in an embodiment of the present disclosure will be described below with reference to FIG. 5.

Specifically, the method performed by a first node includes actions S101 to S102:
S101: obtaining related information of the positioning method or model; and
S102: obtaining positioning information based on the related information of the positioning method or model.

The positioning method or model is also called the first method in the embodiment of the present disclosure, which proposes content that may be performed by the first node in the present disclosure. This method specifically uses AI/ML technology. Corresponding positioning methods or models may be configured under different scenario requirements to perform positioning-related operations, for example obtaining positioning information.

Specifically, for different scenario requirements, the obtained related information of the positioning method or model may be different. Optionally, the related information of the positioning method or model may include at least one of the following: composition-related information of the positioning method or model; type-related information of the positioning method or model; parameter-related information of the positioning method or model; and dataset-related information. The specific content corresponding to each of the related information will be specifically described in subsequent embodiments.

The positioning information that may be obtained based on the related information of the positioning method or model may include at least one of the following: position information (which may be relative coordinate information, absolute coordinate information, etc.); information related to the calculation of position information; time of arrival of a signal; angle of arrival; and angle of departure.

In one of the following embodiments of the present disclosure, the use of the first method proposed in the present disclosure to perform positioning-related operations, for example obtaining positioning information and performing subsequent positioning-related operations based on the positioning information, will be introduced. The first method proposed in the present disclosure uses ML/AI technology. It can perform positioning-related operations and/or acquisition of positioning information not only in poor channel conditions (for example inaccurate channel information) but also in “harsh” conditions (for example non-line-of-sight).

A device using the first method in the present disclosure (represented by device A in the present disclosure) includes one or more of the following parts (also referred to as stages, modes or operations) when using the first method:
Part I: Trigger part, which is optional. In the trigger part, it is configured to determine whether to trigger positioning-related operations and/or acquisition of positioning information, and/or to determine whether to trigger the first method and trigger the processes of the first method. Optionally, in the trigger part, one or more of the following three operations may be included:
Operation 1: Determining whether to trigger a positioning-related operation.

If device A is a network-side device (for example a base station device, an LMF, etc.), the acquisition of positioning information may be triggered by obtaining the requirements of a higher layer (for example the application layer); and/or, if device A is a user equipment (for example a mobile phone, or a vehicle in V2X, etc.), the acquisition of positioning information may be triggered based on the requirements of its own high layer.

Optionally, a positioning-related request may involve the interaction between system nodes, and may also be triggered only based on the requirements of a node itself. The positioning-related request may include a positioning-related request received by a first node which is sent by a second node, and/or a positioning-related request triggered by the first node itself (a received positioning-related request sent by a high layer).

The first node includes one of the following: a user equipment UE that initiates a positioning request, a location management entity for UE positioning and positioning assistance data delivery, a base station gNB or a transmission-reception point for broadcasting positioning assistance data and performing uplink positioning measurement, and a UE for downlink location measurement.

The second node includes one of the following: a user equipment UE that initiates a positioning request, a location management entity for UE positioning and positioning assistance data delivery, a base station gNB or a transmission-reception point for broadcasting positioning assistance data and performing uplink positioning measurement, and a UE for downlink positioning measurement.

Optionally, upon receiving a positioning-related request, the first node may perform a positioning-related operation based on the request, for example obtaining positioning information.
Operation 2: Determining whether a preset trigger condition is met. Optionally, the first node may obtain positioning information when the trigger condition is met.

If the preset trigger condition is met, it is determined to use the first method; if the preset trigger condition is not met, it is determined not to use the first method. In this way, the first method can be used more properly, for example, it can be used when related methods cannot provide desirable results. Optionally, the preset trigger conditions include one or more of the following conditions:
Condition 1: The measured reference signal receiving power (RSRP) value of the first signal is less than (or not greater than) a first threshold value. Optionally, the reference signal receiving power of the first signal includes the reference signal receiving power of the first path and/or the reference signal receiving power of X paths. The X paths may be the X paths with the maximum path impulse response (and/or reference signal receiving power) and/or the X paths with the minimum path delay. The first threshold value is obtained by receiving an instruction and/or is preset. By the trigger condition set for Condition 1, the use of the first method can be triggered only when the channel condition is relatively poor.
Condition 2: The measured path loss of the first signal is greater than (or not less than) a second threshold value. Optionally, the path loss of the first signal includes the path loss of the first path and/or the path losses of X paths. The X paths may be the X paths with the minimum path impulse response and/or the X paths with the minimum path delay. The second threshold value is obtained by receiving an instruction and/or is preset. By the trigger condition set for Condition 2, the use of the first method can be triggered only when the channel condition is relatively poor.
Condition 3: The first method is a valid first method (in a valid state), that is, the first method that passes the test. The test in the embodiment of the present disclosure includes all or part of the operations in the following test part.
Condition 4: Optionally, at least one of the above trigger conditions occurs not less than (or more than) N times, where N is a positive integer not less than 1 and N is obtained by receiving an instruction and/or is preset, for example, the trigger condition counter reaches N+1 times.

The first signal includes reference signals for positioning (for example downlink PRS (positioning reference signal) in a cellular wireless communication system and uplink SRS (sounding reference signal) for positioning, and/or other reference signals in a wireless system, for example, SSB (Synchronization Signal Block) and/or CSI-RS (Channel State Information-Reference Signal), etc.; where the measurement results of the first signal may be used to obtain input training information and/or to input information in the running part.

Optionally, when the first method includes N (a positive integer greater than 1) AI/ML models, the preset trigger condition may be used to determine whether to use M (a positive integer not greater than N) AI/ML models. Optionally, N and M may be values preconfigured by the network device, or values dynamically configured (through DCI and or high-layer signaling).
Operation 3: Executing a triggering process. That is, the first node may receive signaling configured to activate the positioning method or model.

Optionally, a positioning-related operation may be performed by activating the positioning method or model in at least one of the following ways:
the first node indicates to activate a positioning method or model through a first trigger message, sends configuration information related to the positioning method or model, and/or activates the positioning method or model;
the first node receives an instruction to activate a positioning method or model through a second trigger message, receives configuration information related to the positioning method or model, and/or activates the positioning method or model;
the first node requests the second node to trigger a positioning method or model and/or configuration information related to the positioning method or model through a third trigger message, and activates the positioning method or model based on the feedback from the second node; and the first node activates a positioning method or model.

Optionally, the execution of the trigger process includes one or more of the following three sub-operations.
Sub-operation 1: When the network-side device (for example the LMF (with location management function) and/or base station device) triggers the use of the first method according to the above trigger conditions, the network-side device indicates and/or activates the use of the first method through LPP (LTE Positioning Protocol) messages (LPPA signaling), RRC (Radio Resource Control) configuration messages, MAC CEs (Medium Access Control Control Elements) and/or DCI (Downlink Control Information).
Sub-operation 2: When the UE triggers the use of the first method according to the above trigger conditions, the UE receives instructions to use or activate the first method through LPP (LTE Positioning Protocol) messages, RRC (Radio Resource Control) configuration messages, MAC CEs (Media Access Control Control Elements) and/or DCI (Downlink Control Information), or the UE requests the network-side device to use the first method through PUCCHs (Physical Uplink Control Channels), MAC CEs, PRACHs (Physical Random Access Channels) and/or LPP messages. The UE receives feedback from the network-side device on the request to determine whether to use the first method. The feedback includes the way of the network-side device to indicate and/or activate the use of the first method in the above Sub-operation 1.
Sub-operation 3: When the UE triggers the use of the first method according to the above trigger conditions, the UE starts to use the first method. This way may be applied when the first method is deployed on the UE side.
Part II: Configuration information sending and/or receiving part, which is optional. In this part, device A performs sending and/or receiving of the configuration information related to the first method. The sending and/or receiving of the configuration information can help a device that uses the first method and/or trains the first method to use (for example inference) and train it better. The configuration information related to the first method (that is, the related information of the positioning method or model) includes one or more of the following:
Configuration information 1: The model composition of the first method, including: N AI/ML model parts included in the first method. For example, when N=1, the first method has only one AI/ML model; when N=2, the first method may be obtained by combining two AI/ML models; in a similar way, N may be other positive integers and the first method may be obtained by combining multiple AI/ML models. Alternatively, the multiple AI/ML models in this first method may use the same input training data and/or different output training labels.
Configuration information 2: The type of the first method (and/or a single AI/ML model), including at least one of the following: the type determined by AI method, the type determined according to the number of FLOPs of the neural network model, the type determined according to the latency requirement, the type determined according to the required/supported data size (the size of the dataset and/or the size of the data dimension), and the type determined according to the used computing operation (for example convolution and/or matrix operation).
Configuration information 3: Hyperparameter configuration information, including at least one of the following: learning rate, number of layers, batch size, epoch times and clip value. Optionally, other parameters may also be included, which are not listed here. In an embodiment, the hyperparameter is also an item of the parameter-related information of the method or model.
Configuration information 4: Dataset-related parameters, including at least one of the following: the data type of a set of data, the number of parameters of a corresponding data type (for example, a set of data used for positioning includes N channel impulse response values, where the channel impulse response value is the data type, N is the number of parameters of the data type), and the number of data groups; wherein the N is obtained by receiving an instruction and/or is preset.

Optionally, the size of the dataset may be specific to the training part, and/or specific to the test part, and/or common to both the test part and the training part.

Optionally, the number of parameters of a data type in the dataset is determined according to a preset numerical condition. This condition can help to filter out more suitable and effective input information and/or reduce signaling overhead. The preset numerical condition includes at least one of the following:
Numerical condition 1: The number of channel impulse responses based on a third threshold value; specifically, the channel impulse response value greater than (or not less than) the third threshold value; wherein, the third threshold value is obtained by receiving an instruction and/or is preset. For example, there are a total of 4096 channel impulse response values and only N channel impulse responses are greater than the third threshold value, then only the N channel impulse response values are transmitted (sent and/or received); N does not exceed the maximum value Nmax, wherein N and Nmax are obtained by receiving an instruction and/or are preset.
Numerical condition 2: The first N channel impulse responses in terms of time of arrival and/or largest N channel impulse responses in terms of power; specifically, the first N channel impulse response values in terms of time of arrival and/or largest N channel impulse responses in terms of power among all impulse responses, wherein N is obtained by receiving an instruction and/or is preset.

The channel impulse response value includes power value and/or time of arrival of an arrival path.
Configuration information 5: Weight parameter and/or bias parameter configuration, which may include initial values (for example, initial weight parameters and/or initial bias parameter settings obtained according to certain criteria, and/or initial weight parameters and/or initial bias parameter settings obtained according to received signaling) and/or update values (for example, updated weight parameters and/or bias parameter update values obtained by training, updating and/or restoring). Specifically, the determination of the weight parameter and/or bias parameter configuration may be realized by at least one of the following processing methods:
Processing method 1: Initial weight parameter and/or initial bias parameter setting, including the initial weight parameters and/or bias parameters obtained according to the determined probability distribution.
Processing method 2: Setting according to the received weight parameter configuration and/or bias parameter configuration, for example, the weight parameter and/or bias parameter obtained by training or pre-training. This kind of setting may be more suitable for online training, or online training of the first method obtained based on pre-training.
Processing method 3: The weight parameter and/or bias parameter is obtained and/or updated according to a training optimizer model (also known as training optimization algorithm, for example stochastic gradient descent, gradient descent with momentum, etc.) and/or a loss function and/or epoch times optimization intensity and/or a learning rate. For example, what obtained is an updated value.

It may be known that the parameter-related information of the method or model includes at least one of the following: probability distribution used to determine the initial weight parameter and/or bias parameter; weight parameter configuration and/or bias parameter configuration; a training optimization algorithm, a loss function, epoch times and/or a learning rate used to obtain or update the weight parameter and/or bias parameter.

Optionally, the configuration information related to the first method may be sent by device B, and/or sent by other devices (for example device A using the first method) and received by device B.

Optionally, the configuration information may be for one first method model, or a single or multiple AI/ML models in one first method.
Part III: Training part, which is optional. In this part, the first method used needs to be trained with training data to obtain a trained first method. Therefore, a device that can provide training data is represented as device B in the present disclosure. Optionally, in this part, one or more of the following operations may be included:
Operation 1: Confirming the training device (device B). A device that meets one or more of the following conditions may be confirmed as a training device or may be confirmed as a candidate training device (for example, conditions need to be met when the first node is determined as a training device): it has known (or determined) location information; it reports that it can be used as a training device; the state in which it can be used as a training device is activated (for example ON, AVAILABLE, etc.); and certain state conditions are met.

The certain state conditions include one or more of the following state conditions.
State condition 1: The measured first signal is a single-path signal, specifically including: there is only one path for the measured first signal; wherein only one path has the time of arrival and/or received power value meets a set threshold value; wherein the threshold value is obtained by receiving an instruction and/or is preset.
State condition 2: The measured first signal is a line-of-sight signal, specifically including: when the LoS/NLOS indicator is true, that is, the measured first signal is a line-of-sight signal (for example when the indicator is a hard indicator, the indicator being LoS); and/or when the value of the LoS/NLOS indicator (for example when the indicator is a soft indicator) is greater than (not less than) a probability threshold value, that is, the measured first signal has a highly probably of being a line-of-sight signal.

The threshold value is obtained by receiving an instruction and/or is preset.
State condition 3: The measured reference signal receiving power (RSRP) value of the first signal is greater than (not less than) a fourth threshold value; and/or the measured path loss value of the first signal is less than (not greater than) a fifth threshold value. The threshold value is obtained by receiving an instruction and/or is preset.
State condition 4: The transmitting timing error (Tx TE) or transmitting TE group (TEG) of the first signal is less than or (not greater than) a sixth threshold value. The threshold value is obtained by receiving an instruction and/or is preset.
State condition 5: The receiving timing error (Rx TE) or receiving TEG of the first signal is less than or (not greater than) a seventh threshold value. The threshold value is obtained by receiving an instruction and/or is preset.
State condition 6: The Tx and/or Rx TE or TEG of the first signal is less than or (not greater than) an eighth threshold value. The threshold value is obtained by receiving an instruction and/or is preset.
State condition 7: The Tx and/or Rx TE or TEG of the first signal belongs to a specific range (first range). The specific range is obtained by receiving an instruction and/or is preset.
Operation 2: Transmitting and/or receiving resource configuration information used for training. The resource configuration information used for training includes one or more of the following:
configuration information related to the first method described in the training part;
positioning-reference-signal-related configuration information used for training (including index of positioning reference signal configuration, time-frequency resource position of the positioning reference signal, cycle, etc.); and
related configuration of the measurement gap (MG) and/or PRS processing window (PPW) used for training measurement, including the time length, cycle size, time start position of MG and/or PPW, etc. The configuration of the measurement gap used for training may better control the time to obtain training data, because the training data is obtained within a certain time range and is valid for a period of time. For example, beyond a certain time range, the training device may move to other places (for example change its geographical position), and as a result, the training data provided before will no longer be suitable. Only valid training data can help to obtain a suitable and valid first method.
Operation 3: Training the first method according to the confirmed training device and resources used for training, including one or more of the following training operations:
Training operation 1: The training device obtains input information related to the first method according to the obtained resource configuration information for training.
Training operation 2: Optionally, the training device feeds back the obtained input information related to the first method.
Training operation 3: Optionally, the training device feeds back the obtained input information related to the first method and the output information corresponding to the input information. For example, the training device UE feeds the channel impulse response information (that is, the input information related to the first method) obtained by receiving the positioning reference signal and the position information of the training device at this time (including global position information and/or local position information, that is, the output information corresponding to the input information) back to the network-side device. The output information corresponding to the input information may include the position information of device A, and/or information related to the calculation of the position information (for example time of arrival of the signal, angle of arrival, angle of departure), etc. This way is more applicable when the first method is deployed on the network side.
Training operation 4: The first method is trained according to the obtained input information related to the first method and/or output information corresponding to the input information, which are provided by the training device.

Optionally, the input information related to the first method has the same meaning as the aforementioned input training data; and/or the output information corresponding to the input information has the same meaning as the aforementioned output training label.
Training operation 5: Optionally, the input training data (low-noise channel information, which may also represent noise-free channel information) is noised through AI learning to obtain noisy channel information (for example, information with Gaussian noise), and then the obtained noisy channel information is denoised through AI learning to obtain denoised channel information, so that the denoised channel information has the greatest similarity with the input low-noise channel information. Specifically, for the input training data X₀ (taking the channel impulse response value as an example, for example the channel impulse response value in the case of high signal-to-noise ratio), the probability distribution of X₀ is identified as q(x₀), for example, X₀ includes 4096 CIR (Committed Information Rate) values; and it is subjected to an iterative forward process, for example iterating T steps. In each step of iteration, a noise schedule that conforms to the first distribution (represented as q(xₜ|xₜ₋₁) is added to the channel impulse response value (Xₜ₋₁) in the previous step to obtain a channel impulse response value (Xₜ) in a new step. The purpose is to train the channel impulse response value in the case of high signal-to-noise ratio to a channel impulse response value X_{T} conforming to the second distribution;
wherein, the first distribution q(xₜ|xₜ₋₁) may be Gaussian distribution and/or binomial distribution and/or exponential distribution and/or Bernoulli distribution, etc. Optionally, this Gaussian distribution has a mean value sqrt (1−βₜ)×Xₜ₋₁, and the variance is βt1. The βₜ is the noise variance schedule in step t. The selection of the noise variance schedule will affect the training time and/or training effect of the AI/ML model. The noise variance schedule may be based on linear schedule, or cosine schedule, or exponential schedule. Specifically, the schedule way may be selected according to the training purpose of the AI/ML model. For example, in the present disclosure of the present invention, the training data is the impulse response value of the channel path, and the impulse response value exponentially declines according to the time delay of the channel path. Therefore, the selection of exponential schedule may be more in line with the scenario in the present disclosure of the present invention, for example, βₜ=a+exp(b*/t/T), where a and b are related configuration parameters that make βₜ less than (not greater than) a certain threshold value and/or gradually increase from t=1 to t=T; and/or
the second distribution may be Gaussian distribution or binomial distribution, and the corresponding second distribution may be selected according to the training purpose of the AI/ML model. For example, in the present disclosure, noise in the wireless communication scenario is taken into consideration. According to the central limit theorem, due to various factors, it is more appropriate to select Gaussian distribution;

Optionally, the obtained X_{T} is further denoised. The probability distribution of X_{T} is identified as p(x_{T}), and it is subjected to an iterative backward process, for example, iterating T steps. In each step of the iteration, the channel impulse response value (Xₜ) in the t^{th} step is learned through a neural network to obtain a third distribution (represented as p(xₜ₋₁|xₜ) and a channel impulse response value (Xₜ₋₁) in a new (t−1)^{th} step so that the distribution of the final X₀ (represented as p(X0)) has the greatest similarity with that of q(X₀). The purpose is to train the simulated noisy channel impulse response value X_{T} to conform to the channel impulse response value X₀ in the fourth distribution, so that X′₀ can approach X₀. Optionally, learning through a neural network includes optimizing the parameter configuration of the AI/ML model by minimizing the loss function. Optionally, the distribution of the final X₀ (represented as p(X₀)) having the greatest similarity with that of q(X₀) includes: maximizing the expected log function for p(X₀).

The value of type and/or expectation and/or variance of the first distribution and/or the second distribution and/or the third distribution and/or the fourth distribution may be preconfigured, or dynamically configured through DCI (and/or high-layer signaling) from the base station device.
Training operation 6: Optionally, [the second training method]: the parameter configuration of the AI/ML model in the first method (for example, the configuration information related to the first method) is adjusted according to the input training data (taking the channel impulse response value as an example, for example, the channel impulse response value in the case of high signal-to-noise ratio) and the output training label, so that the output information obtained according to the training data has the greatest similarity with the output training label. For example, the first method is a supervised learning model, for example DenseNet, etc.

Optionally, the AI/ML model in the first method may also be used for information restoration. During the training process, the positioning method or model may be trained based on the input information to obtain incomplete information to initiate recovery operation. The information to initiate recovery operation is restored through the positioning method or model to obtain the output information.
Operation 4: Determining the trained first method and/or configuration information related to the trained first method, including one or more of the following adjustment operations:
Adjustment operation 1: During the training process, the configuration information related to the first method is adjusted to obtain the trained configuration information related to the first method, in order to obtain a new first method. Optionally, this way is more applicable for the case where the training part of the device using the first method is performed.
Adjustment operation 2: According to the trained configuration information related to the first method, the configuration information related to the first method is adjusted to obtain a new first method. Optionally, this way is more applicable for the case where the training part of the device using the first method is not performed while the trained updated configuration information of the first method is obtained from other devices to obtain a new first method.
Part IV: Test part, which is optional. In this part, it is configured to test the validity of the used first method. If the used first method is confirmed to be valid, then a valid first method may be obtained; if the used first method is confirmed to be invalid, an invalid first method may be obtained, and then the process goes back to the trigger part to re-determine the first method to be used. In this part, the test may be triggered based on events and/or based on counting/timing. For the specific content of the event-based trigger and/or the counting/timing-based trigger, please refer to the specific description in the update part below. The test is to determine whether the first method obtained after training is really valid and effected in the current situation. Optionally, the positioning information may be obtained when it is determined that the positioning method or model is valid. Optionally, determining the validity of the positioning method or model includes:
Test operation 1: Obtaining test data (first data). The test data is data used to test the validity of the used first method, including the input information of the used first method and/or the output information corresponding to the input information. Optionally, the input information of the used first method and/or the output information corresponding to the input information may be from device B and/or device C that specially provides test data.
Test operation 2: Determining the validity of the tested first method. It is determined that the positioning method or model is valid when the output information obtained by the positioning method or model based on the input information in the first data meets any of the following preset conditions. If the first method can successfully pass the test, for example, the test output information obtained by using the first method and the input information in the test data meets a preset condition, it is determined that the tested first method is valid. The preset conditions include:
Condition 1: The difference between the test output information and the output information in the test data is less than (or not greater than) a first test threshold value, wherein the first test threshold value is obtained by receiving an instruction and/or is preset. This way is applicable for the comparison of positioning accuracy. For example, the test output information is the positioning position information of device C obtained by using the first method and the test input information, while the output information in the test data is the real positioning position information of device C. By comparing the difference between the two, a positioning error is obtained. The smaller the positioning error, the more accurate the positioning result obtained by the first method is. When the obtained positioning error is less than (or not greater than) a set first threshold value, it may be determined that the tested first method passes the test; otherwise fails.
Condition 2: The model performance corresponding to the output information is better than (not inferior to) the model performance corresponding to the output information in the test data.
Test operation 3: Completing the test process. When it is determined that the tested first method is valid, and/or when the tested first method meets the certain conditions, it may be considered that the test process is successfully completed; and when it is determined that the tested first method is invalid, and/or when the tested first method does not meet the certain conditions, it may be considered that the test process is not successfully completed.

Optionally, the used first method may be a trained first method, and/or a first method obtained according to the trained configuration information related to the trained first method;
Part V: Running (or inference) part. In this part, according to the obtained input information, the obtained (or determined) first method and/or the configuration information related to the first method are used to obtain the output information. Optionally, in this part, one or more of the following running operations may be included:
Running operation 1: Determining the parameter configuration related to the used first method, including:

The parameter configuration information related to the first method includes the same parameter configuration information as the parameter configuration information related to the first method introduced in the training part. Optionally, the parameter configuration information is obtained by device A by receiving configuration signaling sent by other devices. For example, device A is a UE, which determines the parameter configuration information required by the currently used first method by receiving the parameter configuration information of the first method trained by the network-side device; and/or

The determined parameter configuration information is used to configure the first method. Optionally, the low layer (for example the physical layer) receives a parameter configuration indicator from the high layer to configure the first method.
Running operation 2: Obtaining input information related to the used first method. The input information may be obtained in at least one of the following ways:
obtaining the input information related to the first method by receiving and/or measuring the first signal;
obtaining the input information related to the first method by receiving feedback from other devices (for example the second node); and optionally, the input information includes dataset-related parameters in the configuration information related to the first method in the training part.
Running operation 3: Obtaining output information by using the first method based on the input information. Optionally, when the input information meets certain conditions (for example meets the conditions in the trigger part), the first AI/ML model in the first method is used to perform inference, and the output information obtained by the inference is used as output information of the second AI/ML model in the used first method obtained by performing inference.

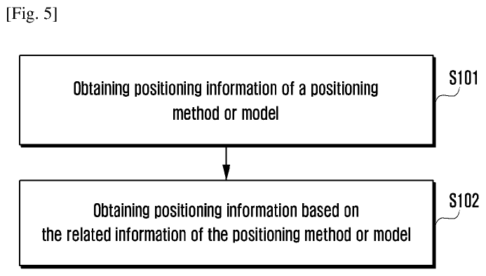

Optionally, the positioning method or model may include multiple execution modules (for example, may include a first module and a second module), and each execution module may be a machine learning model determined using the AI/ML technology. In the following embodiments, as shown in FIG. 6, model 1 and model 2 are used to describe the modules included in the positioning method or model.

Specifically, in the following example, the input information is the channel impulse response, the first method includes two AI/ML models, model 1 is obtained according to the first training method; model 2 is obtained according to the second training method, and the output information is the detailed position information corresponding to channel impulse.

Optionally, the first noise value corresponding to the input information is compared with a first noise threshold value to determine whether the input information needs to initiate denoise operation. As shown in FIG. 6, the input information W=(X₀+Z), where Z is the noise item, is used as XT and compared with the first noise threshold value (for example, RSRP is less than the threshold value, and/or path loss is greater than the threshold value), then device A determines that the input information needs to initiate denoise operation by using model 1 in the first method (for example, the denoising operation performed by using model 1 as shown in FIG. 6) to obtain first denoised information X′₀. When X′₀ is estimated (for example maximum a posterior, (MAP) estimation, or minimum mean square error (MMSE) estimation), it is necessary to integrate the values in the previous T−1 steps, for example, integrate X1, X2 . . . XT to obtain X0. For ease of calculation, in the embodiments of the present disclosure, the CIR in the t^{th} step is defined as Wₜ=Xₜ+Zₜ, that is, a truth value Xₜ plus a noise value Zₜ. The selected Wₜ has an important impact on the result of the operation. For example, Wₜ may be equal to W, so that being the same noisy channel information as the obtained input information in each step. Or, Wₜ may be equal to a linear change value based on W, for example Wₜ=sqrt[(T−t)/T]*W=Xt+sqrt[(T−t)/T]*Z, the advantage of doing this is to make W_{T} be Gaussian white noise when it is just input, which is similar to the first training method, and this is conducive to realize best denoising effect of model 1; and then the obtained X′₀ is input into model 2 in the first method to obtain the positioning-related output information corresponding to W.

Optionally, as shown in FIG. 6, the input information W=(X₀+Z), where Z is the noise item, is used as X_{T} and compared with the first noise threshold value (for example, RSRP is not less than the threshold value, and/or path loss is not greater than the threshold value), and W is input into model 2 in the first method to obtain the positioning-related output information corresponding to W.

The first noise value includes at least one of the following: RSRP, SNR, CIR amplitude value, and CIR arrival time value.

Optionally, this method may also be extended to scenarios where the number of channel impulse responses (CIRs) is incomplete (for example information restoration). For example, if the number of CIRs in the input information W is less than (not greater than) the first CIR threshold value, device A determines that the input information needs to initiate recovery operation using model 1 in the first method. The dimension of the input training data is set as N, and a mask vector is represented as M and M belongs to {0,1}^{N}, where if the i^{th} element is missing, it means that the i^{th} element is 0, M(i)=0; and if the i^{th} element exists, it means that the i^{th} element is 1, M(i)=1. Other operating methods are the same as the above method except that, when M(i)=0, X_{T}(i) is represented as 0; and when M(i)=1, X_{T}(i) is represented as W(i) (that is, used for test or as input information).

Optionally, when the number of CIRs in the input information (the channel information shown in FIG. 6) is greater than the corresponding threshold value, the input information is processed through model 2 in the first method to obtain the positioning-related output information (for example position information shown in FIG. 6).

Optionally, determining whether the input information needs to initiate recovery operation based on channel impulse responses corresponding to the input information includes:
comparing the channel impulse response CIR value corresponding to the input information with a first CIR threshold value to obtain a valid CIR value; and
comparing the number of valid CIR values with a first threshold value of the number of CIRs to determine whether the input information needs to initiate recovery operation.

Valid CIR values in the input information are first screened out, and then the number of valid CIR values is compared with a corresponding first threshold value of the number of CIRs, as shown in FIG. 6. When the number of valid CIR values is lower than the threshold value, model 1 is used to carry out the restoration, and the first restoration information obtained after the restoration process may be input into the model 2 to output the position information; otherwise, the input information is directly input into the model 2 to output the position information.

Optionally, the obtained (or determined) first method further includes a first method obtained through testing and/or a valid first method.

Optionally, the output information may include position information of device A, and/or information related to the calculation of the position information (for example, time of arrival, angle of arrival, and angle of departure) and the like.
Part VI: Update part, which is optional. When the first method is used, the used first method and/or the configuration information related to the used first method may change, for example due to change in the environment (for example the change in channel conditions, etc.), it is necessary to adjust the used first method and/or the configuration information related to the used first method, for example update the related information of the positioning method or model. The advantage of this update is that the first method can be modified with less effort and/or in a shorter time so that it can work again. Optionally, in this part, one or more of the following update operations may be included:
Update operation 1: Triggering an update process, including event-based update trigger and/or counting/timing-based update trigger, specifically including preset event-based update trigger and/or counting/timing-based update trigger.

Event-based update trigger: when a preset event occurs, the update of the first method is started. Specifically, the preset event includes one or more of the following events.
Event 1: When the output information of the first method does not meet the required threshold value, wherein the threshold value is obtained by receiving an instruction and/or is preset. For example, when the first method is used to obtain positioning information, the difference between the output positioning position obtained by using the first method and the real positioning position (or the expected positioning position, or the positioning position obtained by other methods, etc.) is greater than a certain threshold value. Optionally, the threshold value may be an uncertainty range of the position information.
Event 2: When the number and/or type of the input information obtained do not meet the required threshold value, wherein the threshold value is obtained by receiving an instruction and/or is preset. For example, when the first method is used to obtain positioning information, device A does not obtain enough channel impulse response information and the first method cannot be used to obtain positioning position information; for example:
obtaining input information provided by less than or no more than N devices, wherein the N is obtained by receiving an instruction and/or is preset;
obtaining measurement results of less than or no more than N positioning reference signal resources, wherein the N is obtained by receiving an instruction and/or is preset; and obtaining less than or no more than N pieces of CIR/RSRP/angle-related/phase-related information, wherein the N is obtained by receiving an instruction and/or is preset.

Counting and/or timing-based update trigger: which includes combinations of one or more of the following conditions and operations:
when determining to use the first method or receiving an instruction to use the first method, initially setting the running counter of the first method to 1 and/or starting the running timing of the first method;
when an event described in the above-mentioned event-based trigger occurs, the running counter is incremented by 1 and/or the counter of the first method terminates timing (or determined to be expired);
when a running cycle ends, the running counter is incremented by 1 and/or the counter of the first method terminates counting (or determined to be expired); the running cycle includes: according to the obtained input information of the first method, applying the first method to obtain the output information. Optionally, the output information is output information that meets the requirements (for example, the difference between the output positioning position and the real positioning position (or the expected positioning position, or the positioning position obtained by other methods, etc.) is less than or not greater than a certain threshold value);

Optionally, when the output information that meets the requirements is obtained, the running counter is incremented by 1 and/or the counter of the first method terminates counting (or determined to be expired); and
When the value counter_value of the counter reaches or exceeds the set maximum value max (for example, counter_value=max+1), the termination part and/or the update part and/or the recovery part may be performed.
Update operation 2: Updating the used first method and/or configuration information related to the used first method, including: sending and/or obtaining the configuration information needs to be updated; specifically, including one or more of the following:
training, including all or part of the operations in the above training part, to obtain updated configuration information related to the first method;
requesting other devices to update the configuration information related to the first method;
receiving updates of the configuration information related to the first method sent by other devices; and
optionally, performing a test, the test including all or part of the operations in the test part above.
Part VII: Recovery part, which is optional. When the used first method does not meet the performance requirements or does not work properly, it may be necessary to recover the used first method and/or configuration information related to the used first method, for example recover the related information of the positioning method or model. The recovery may be able to correct the first method with greater intensity and/ or within a long period of time so that it can work again. Optionally, in this part, one or more of the following operations may be included:

Triggering a recovery process: when a certain trigger condition is met, a recovery process is triggered. The certain trigger condition includes:
the preset event in the above-mentioned event-based update trigger; optionally, the preset event occurs up to or not less than N times, wherein the N is obtained by receiving an instruction or is preset;
conditions and/or operations in the above-mentioned counting and/or timing-based update trigger; and
the recovery may be triggered based on events and/or based on counting/timing. For the specific content of the event-based trigger and/or the counting/timing-based trigger, please refer to the specific description in the update part above.

Performing recovery, including: searching for new (or candidate) training devices and/or training resources and/or training data to train and/or to update.

Determining the recovery result, including: obtaining the recovered first method or configuration information related to the first method. Optionally, the recovered first method or configuration information related to the first method also includes: testing the recovered first method or the first method obtained according to the configuration information related to the first method, and obtaining the recovered first method and/or the configuration information related to the first method based on the test results.
Part VIII: Termination part, which is optional. When the used first method has been used for a certain period of time and/or does not meet the requirements and/or fails to work properly, the used first method and/or configuration information related to the used first method may be terminated. For example, the use of the related information of the positioning method or model is terminated. Optionally, in this part, one or more of the following operations may be included:

Terminating according to the termination trigger condition. The termination trigger condition includes all or part of trigger conditions in the above-mentioned recovery trigger process. Optionally, the termination may be triggered based on events and/or based on counting/timing. For the specific content of the event-based trigger and/or the counting/timing-based trigger, please refer to the specific description in the update part above.

Optionally, the operations in the trigger part, the configuration information sending and/or receiving part, the training part, the test part, the running (inference) part, the update part, the recovery part and the termination part may be exchanged, combined and/or or replaced with each other.

Optionally, the device A and/or device B may be a network device, a user equipment, or a device supporting bypass communication.

Optionally, the first method described in the present disclosure may be replaced by one or more AI/ML models in the first method.

As an example, embodiment of the present disclosure, the method for performing a positioning operation may simply include a training part and a running part.

As another exemplary embodiment of the present disclosure, the method for performing a positioning operation may basically include a training part, a test part, and a running part.

As yet another exemplary embodiment of the present disclosure, the method for performing a positioning operation may include a training part, a test part, a training part, a test part, a training part, a test part, a running part and a termination part.

As yet another exemplary embodiment of the present disclosure, the method for performing a positioning operation may include a training part, a test part, a running part, an update part, a running part, an update part and a termination part;

As yet another exemplary embodiment of the present disclosure, the method for performing a positioning operation may include a training part, a test part, a running part, an update part, a running part, an update part and a termination part;

As yet another exemplary embodiment of the present disclosure, the method for performing a positioning operation may include a training part, a test part, a running part, an update part, a test part (failed), an update part, a test part (failed), an update part, a test part (failed) and a termination part.

As yet another exemplary embodiment of the present disclosure, the method for performing a positioning operation may include a training part, a test part, a running part, an update part, a test part (failed), an update part, a test part (failed), an update part, a test part (failed), a recovery part, a test part, a running part, an update part, a test part, and a termination part.

The above exemplary embodiments are only for illustration, and those skilled in the art may make various adaptive changes within the protection scope of the present disclosure.

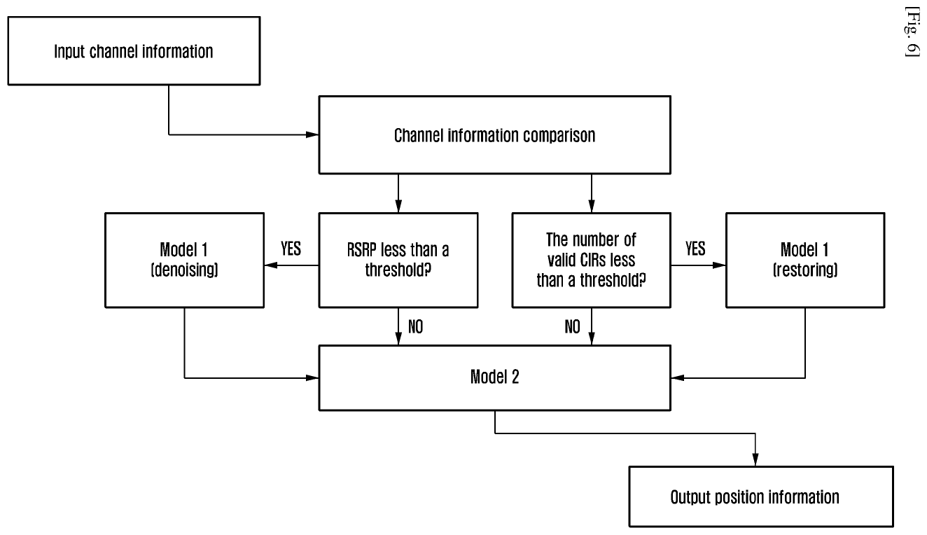

An embodiment of the present disclosure provides an apparatus performed by a first node. As shown in FIG. 7, the apparatus 100 may include a first obtaining module 101 and a second obtaining module 102.

The first obtaining module 101 is configured to obtain related information of the positioning method or model; and the second obtaining module 102 is configured to obtain information based on the positioning-related information of the positioning method or model.

The apparatus of the embodiment of the present disclosure can execute the method of the embodiments of the present disclosure, and the implementation principles thereof are similar. The actions performed by modules in the apparatus of the embodiment of the present disclosure correspond to the steps in the method of the embodiments of the present disclosure. Correspondingly, for the detailed functional description of modules of the apparatus, reference may be made to the description in the corresponding method shown above, and details will not be repeated here.

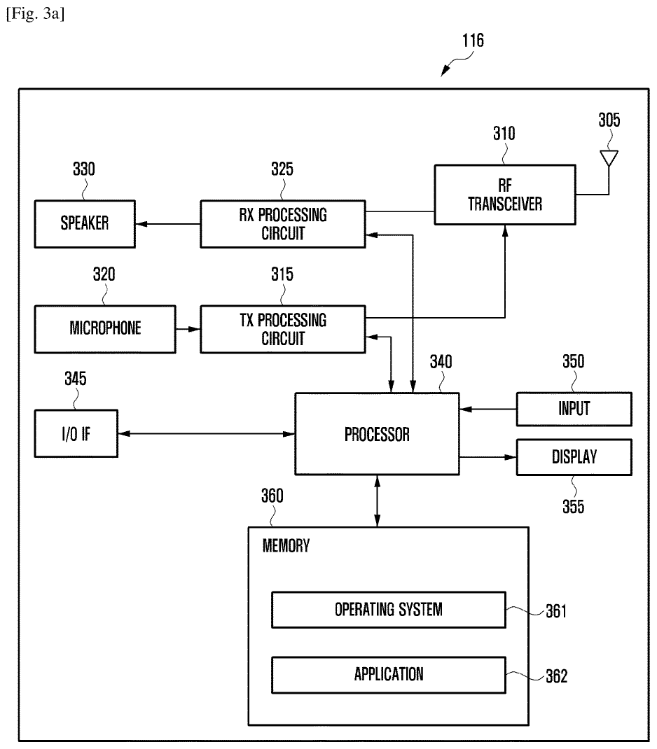

Referring to FIG. 4, an embodiment further provides an electronic device (user equipment) 500 used in a method for receiving and measuring a positioning signal. Specifically, the electronic device includes a transceiver and a controller. The controller is coupled to the transceiver and configured to execute the method performed by a first node.

Optionally, the user equipment includes a memory 501 and a processor 502. The memory has computer-executable instructions stored therein that, when executed by the processor 502, execute at least one of methods corresponding to the foregoing embodiments of the present disclosure. What described above are merely preferred embodiments of the present disclosure and not intended to limit the present disclosure. Any modifications, equivalent replacements and improvements made within the spirit and principle of the present disclosure should be included in the protection scope of the present disclosure.

It may be appreciated by those skilled in the art that the present disclosure includes devices for performing one or more of the operations described in the present disclosure. These devices may be specially designed and fabricated for the stated purposes, or they may include known devices found in general-purpose computers. These devices have computer programs stored therein that are selectively activated or reconfigured. Such computer programs may be stored in device (e.g., computer)-readable media, or any type of media suitable for storing electronic instructions and being respectively coupled to a bus. The computer-readable media include, but are not limited to, any type of disks (including floppy disks, hard disks, optical disks, CD-ROMs, and magneto-optical disks), ROMs (Read-Only Memories), RAMs (Random Access Memories), EPROMs (Erasable Programmable Read-Only Memories), EEPROMs (Electrically Erasable Programmable Read-Only Memories), flash memories, magnetic cards or optical cards. That is, the readable media include any media that store or transmit information in a form readable by devices (e.g., computers).

An embodiment of the present disclosure provides an electronic device, including a transceiver, a memory, a processor, and a computer program stored on the memory. The processor executes the computer program to implement the steps performed by the first node.

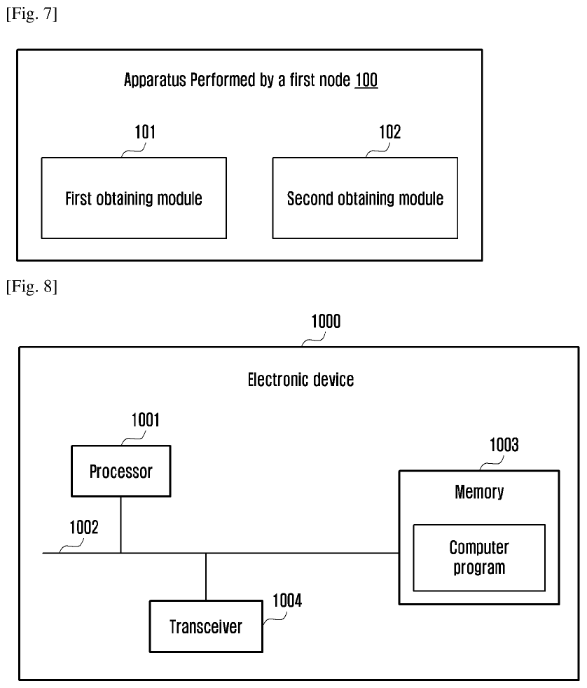

In an optional embodiment, an electronic device is provided, as shown in FIG. 8, wherein the electronic device 1000 shown in FIG. 8 includes a processor 1001 and a memory 1003. Wherein, the processor 1001 communicates with the memory 1003, e.g., via a bus 1002. Optionally, the electronic device 1000 may also include a transceiver 1004, which may be used for data interaction between this electronic device and other electronic devices, such as data transmission and/or data reception. It should be noted that the transceiver 1004 is not limited to one in practical applications, and the structure of the electronic device 1000 does not constitute a limitation of this application embodiment.

The processor 1001 may be a central processing unit (CPU), a general-purpose processor, a digital signal processor (DSP), an application specific integrated circuit (ASIC), and a field programmable gate array (FPGA), or other programmable logic devices, transistor logic device, hardware component, or any combination thereof. It is possible to implement or execute the various exemplary logical blocks, modules, and circuits described in combination with the disclosures of the present disclosure. The processor 1001 may also be a combination of computing functions, such as a combination of one or more microprocessors, a combination of a DSP and a microprocessor, and so on.

The bus 1002 can include a path for delivering information among the above components. The bus 1002 may be a peripheral component interconnect (PCI) bus or an extended industry standard architecture (EISA) bus. The bus 1002 may be divided into an address bus, a data bus, a control bus, and so on. For ease of illustration, only one bold line is shown in FIG. 8, but does not indicate that there is only one bus or type of bus.

The memory 1003 may be a read-only memory (ROM) or other types of static storage devices that can store static information and instructions, a random-access memory (RAM) or other types of storage devices that can store information and instructions. The memory 1003 may also be electrically erasable programmable read-only memory (EEPROM), compact disc read-only memory (CD-ROM), or other optical disk storage, optical disk storage (including compressed compact disc, laser disc, compact disc, digital versatile disc, blue-ray disc, etc.), magnetic disk storage medium or other magnetic storage devices, or any other medium capable of carrying or storing computer programs and capable of being accessed by a computer, but not limited to this.

The memory 1003 is used to store computer programs for executing embodiments of the present disclosure and is controlled for execution by the processor 1001. The processor 1001 is used to execute the computer program stored in memory 1003 to implement the steps shown in the preceding method embodiment.

The electronic devices include, but are not limited to, smartphones, tablet computers, notebook computers, smart speakers, smart watches, vehicle-mounted devices, and so on.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

In the embodiments of the present disclosure, the method performed by the first node may be performed by using an artificial intelligence model.

The device provided in the present disclosure can realize at least one module of multiple modules through AI model. Functions associated with AI can be performed through non-volatile memory, volatile memory, and processor.

The processor may include one or more processors. In this case, the one or more processors may be a general purpose processor, (e.g., a central processing unit (CPU), an application processor (AP), etc.), or a pure graphics processing unit, (e.g., a graphics processing unit (GPU), a visual processing unit (VPU), and/or an AI-specific processor, (e.g., a neural processing unit (NPU))).

The one or more processors control the processing of the input data according to predefined operating rules or artificial intelligence (AI) models stored in the non-volatile memory and the volatile memory. The predefined operation rules or AI models are provided by training or learning.

Here, providing by learning refers to obtaining predefined operating rules or AI models with desired characteristics by applying learning algorithms to a plurality of learned data. The learning may be performed in the device itself in which the AI according to the embodiment is executed, and/or may be implemented by a separate server/system.

The AI model may comprise a layer including a plurality of neural networks. Each layer has a plurality of weight values, and the computation of a layer is performed by the results of the computation of the previous layer and the plurality of weights of the current layer. Examples of neural networks include, but are not limited to, convolutional neural networks (CNN), deep neural networks (DNN), recurrent neural networks (RNN), restricted Boltzmann machines (RBM), deep belief networks (DBN), bidirectional recurrent deep neural networks (BRDNN), generative adversarial networks (GAN), and deep Q networks.

A learning algorithm is a method of training a predetermined target device (e.g., a robot) using multiple learning data to enable, allow, or control the target device to make determinations or predictions. Examples of the learning algorithm include, but are not limited to, supervised learning, unsupervised learning, semi-supervised learning, or reinforcement learning.

It may be understood by a person of ordinary skill in the art that computer program instructions may be used to realize each block in structure diagrams and/or block diagrams and/or flowcharts as well as a combination of blocks in the structure diagrams and/or block diagrams and/or flowcharts. It may be understood by a person of ordinary skill in the art that these computer program instructions may be provided to general purpose computers, special purpose computers or other processors of programmable data processing means to be implemented, so that solutions designated in a block or blocks of the structure diagrams and/or block diagrams and/or flow diagrams are executed by computers or other processors of programmable data processing means.

It may be understood by a person of ordinary skill in the art that the operations, methods, steps in the flows, measures and solutions already discussed in the present disclosure may be alternated, changed, combined or deleted. Further, the operations, methods, other steps in the flows, measures and solutions already discussed in the present disclosure may also be alternated, changed, rearranged, decomposed, combined or deleted. Further, prior arts having the operations, methods, the steps in the flows, measures and solutions already discussed in the present invention may also be alternated, changed, rearranged, decomposed, combined or deleted.

The foregoing descriptions are merely some implementations of the present disclosure. It should be noted that, to a person of ordinary skill in the art, various improvements and modifications may be made without departing from the principle of the present disclosure, and these improvements and modifications shall be deemed as falling into the protection scope of the present disclosure.

1-15. (canceled)

16. A method performed by a first node in a communication system, the method comprising:
obtaining information on a positioning model;
obtaining positioning information based on the information on the positioning model; and
performing a positioning related operation based on the positioning information.

17. The method of claim 16, wherein the information on the positioning model includes at least one of:
information on a composition related to the positioning model;
information on a type related to the positioning model;
information on a parameter related to the positioning model; or
information on a dataset,
wherein the information on the dataset includes number-related information,
wherein the number-related information includes at least one of:
a number of channel impulse responses based on a third threshold value, or
a first number of channel impulse responses in terms of time of arrival or of largest channel impulse responses in terms of power, and
wherein the information on the parameter related to the positioning model includes at least one of:
a probability distribution for determining initial weight parameters or bias parameters,
a weight parameter configuration,
a bias parameter configuration, or
a training optimization algorithm, a loss function, epoch times, or a learning rate for obtaining or updating weight parameters or bias parameters.

18. The method of claim 16, wherein the positioning information includes at least one of:
position information,
information related to a calculation of the position information,
a time of arrival of a signal,
an angle of arrival, or
an angle of departure.

19. The method of claim 16, wherein obtaining the positioning information comprises:
obtaining input information including information on a dataset; and
obtaining the positioning information based on the input information,
wherein obtaining the input information comprises at least one of:
obtaining the input information by receiving or measuring a first signal; or
receiving the input information from a second node,
wherein obtaining the positioning information based on the input information comprises at least one of (a) or (b):
(a) determining, based on a first noise value corresponding to the input information, whether the input information initiates a denoise operation;
in case that the input information initiates the denoise operation, processing the input information through a first module of the positioning model to obtain first denoised information, and processing the first denoised information through a second module of the positioning model to obtain the positioning information; and
in case that the input information does not initiate the denoise operation, processing the input information through the second module to obtain the positioning information; or
(b) determining, based on a channel impulse response value corresponding to the input information, whether the input information initiates a recovery operation;
in case that the input information initiates recovery operation, processing the input information through a first module for the positioning model to obtain first recovered information, and processing the first recovered information through the second module for the positioning model to obtain the positioning information; and
in case that the input information does not initiate recovery operation, processing the input information through the second module to obtain the positioning information, and
wherein the first noise value comprises at least one of a reference signal receiving power (RSRP), a signal to noise ratio (SNR), a channel impulse response (CIR) amplitude value, or a CIR arrival time value.

20. The method of claim 19, wherein determining, based on the first noise value corresponding to the input information, whether the input information initiates the denoise operation comprises comparing the first noise value corresponding to the input information with a first noise threshold value.

21. The method of claim 19, wherein determining, based on the channel impulse response value corresponding to the input information, whether the input information initiates the recovery operation comprises:
comparing a CIR value corresponding to the input information with a first CIR threshold value to obtain a valid CIR value; and
comparing a number of valid CIR values with a first threshold value of a number of CIRs.

22. The method of claim 16, further comprising at least one of:
determining whether to trigger the positioning related operation based on a positioning related request, wherein the positioning related request is received from a second node or a higher layer;
determining whether to obtain the positioning information based on trigger conditions; or
receiving signaling configured to activate the positioning model.

23. The method of claim 16, wherein the positioning information is obtained in case that at least one of the following trigger conditions is met:
a measured reference signal receiving power (RSRP) value of a first signal is less than or equal to a first threshold value,
a measured path loss of the first signal is greater than or equal to a second threshold value,
the positioning model is in a valid state, or
the at least one of the trigger conditions occurs greater than or equal to a preset number of times, and
wherein the first signal includes at least one of a positioning reference signal, a sounding reference signal, a reference signal of a synchronization signal block, or a reference signal of channel state information.

24. The method of claim 16, further comprising:
determining a validity of the positioning model based on a first data; and
in case that the positioning model is valid, obtaining the positioning information,
wherein the positioning model is valid, in case that output information obtained by the positioning model based on input information in the first data meets at least one of the following conditions:
a difference between the output information obtained by the positioning model and output information in the first data is less than or equal to a test threshold value, or
model performance corresponding to the output information obtained by the positioning model is better than model performance corresponding to the output information in the first data.

25. The method of claim 16, further comprising at least one of:
triggering, based on a preset event, counting information, or timing information, an update of the information on the positioning model;
triggering, based on the preset event, the counting information, or the timing information, recovery of the information on the positioning model; or
terminating, based on the preset event, the counting information, or the timing information, use of the information on the positioning model,
wherein the preset event comprises at least one of:
output information for the positioning model does not meet a first required threshold value, or
a number of input information for the positioning model or a type of the input information for the positioning model does not meet a second required threshold value,
wherein the timing information comprises at least one of:
a first start time of the positioning model determined to be used,
a second start time corresponding to the preset event, or
a termination time corresponding to the preset event, and
wherein the counting information comprises at least one of:
an initial value corresponding to the preset event, or
an accumulated value corresponding to an occurrence of the preset event.

26. A first node in a communication system, the first node comprising:
a transceiver; and
a processor coupled with the transceiver, the processor configured to:
obtain information on a positioning model,
obtain positioning information based on the information on the positioning model, and
perform a positioning-related operation based on the positioning information.

27. The first node of claim 26, wherein the information on the positioning model includes at least one of:
information on a composition related to the positioning model;
information on a type related to the positioning model;
information on a parameter related to the positioning model; or
information on a dataset,
wherein the information on the dataset includes number-related information,
wherein the number-related information includes at least one of:
a number of channel impulse responses based on a third threshold value, or
a first number of channel impulse responses in terms of time of arrival or of largest channel impulse responses in terms of power, and
wherein the information on the parameter related to the positioning model includes at least one of:
a probability distribution for determining initial weight parameters or bias parameters,
a weight parameter related configuration,
a bias related parameter configuration, or
a training optimization algorithm, a loss function, epoch times, or a learning rate, for obtaining or updating weight parameters or bias parameters.

28. The first node of claim 26, wherein the positioning information includes at least one of:
position information,
information related to a calculation of the position information,
a time of arrival of a signal,
an angle of arrival, or
an angle of departure.

29. The first node of claim 26, wherein to obtain the positioning information, the processor is further configured to:
obtain input information including information on a dataset,
obtain the positioning information based on the input information,
wherein to obtain input information, the processor is further configured to perform at least one of:
obtain the input information by receiving or measuring a first signal, or
receive the input information from a second node,
wherein to obtain the positioning information based on the input information, the processor is further configured to at least one of (a) or (b):
(a) determine, based on a first noise value corresponding to the input information, whether the input information initiates a denoise operation,
in case that the input information initiates the denoise operation, process the input information through a first module of the positioning model to obtain first denoised information, and process the first denoised information through a second module of the positioning model to obtain the positioning information, and
in case that the input information does not initiate the denoise operation, process the input information through the second module to obtain the positioning information, or
(b) determine, based on a channel impulse response value corresponding to the input information, whether the input information initiates a recovery operation,
in case that the input information initiates the recovery operation, process the input information through a first module for the positioning model to obtain first recovered information, and process the first recovered information through the second module for the positioning model to obtain the positioning information, and
in case that the input information does not initiate the recovery operation, process the input information through the second module to obtain the positioning information, and
wherein the first noise value comprises at least one of a reference signal receiving power (RSRP), a signal to noise ratio (SNR), a channel impulse response (CIR) amplitude value, or a CIR arrival time value.

30. The first node of claim 29, wherein to determine, based on the first noise value corresponding to the input information, whether the input information initiates denoise operation, the processor is further configured to compare the first noise value corresponding to the input information with a first noise threshold value.

31. The first node of claim 29, wherein to determine, based on the channel impulse response value corresponding to the input information, whether the input information initiates the recovery operation, the processor is further configured to:
compare a CIR value corresponding to the input information with a first CIR threshold value to obtain a valid CIR value; and
compare a number of valid CIR values with a first threshold value of a number of CIRs.

32. The first node of claim 26, wherein the processor is further configured to perform at least one of:
determine whether to trigger the positioning related operation based on a positioning related request, wherein the positioning related request is received from a second node or a higher layer,
determine whether to obtain the positioning information based on trigger conditions, or
receive signaling configured to activate the positioning model.

33. The first node of claim 26, wherein the positioning information is obtained in case that at least one of the following trigger conditions is met:
a measured reference signal receiving power (RSRP) value of a first signal is less than or equal to a first threshold value,
a measured path loss of the first signal is greater than or equal to a second threshold value,
the positioning model is in a valid state, or
the at least one of the trigger conditions occurs greater than or equal to a preset number of times, and
wherein the first signal includes at least one of a positioning reference signal, a sounding reference signal, a reference signal of a synchronization signal block, or a reference signal of channel state information.

34. The first node of claim 26, wherein the processor is further configured to:
determine a validity of the positioning model based on a first data, and
in case that the positioning model is valid, obtain the positioning information,
wherein the positioning model is valid, in case that output information obtained by the positioning model based on input information in the first data meets at least one of the following preset conditions:
a difference between the output information obtained by the positioning model and output information in the first data is less than or equal to a test threshold value, or
model performance corresponding to the output information obtained by the positioning model is better than model performance corresponding to the output information in the first data.

35. The first node of claim 26, wherein the processor is further configured to perform at least one of:
trigger, based on a preset event, counting information, or timing information, an update of the information on the positioning model,
trigger, based on the preset event, the counting information, or the timing information, recovery of the information on the positioning model, or
terminate, based on the preset event, the counting information, or the timing information, use of the information on the positioning model,
wherein the preset event comprises at least one of:
output information for the positioning model does not meet a first required threshold value; or
a number of input information for the positioning model or a type of the input information for the positioning model does not meet a second required threshold value,
wherein the timing information comprises at least one of:
a start time of the positioning model determined to be used,
a start time corresponding to the preset event, or
a termination time corresponding to the preset event, and
wherein the counting information comprises at least one of:
an initial value corresponding to the preset event, or
an accumulated value corresponding to an occurrence of the preset event.
